(19) United States
(12) Patent Application Publication
(10) Pub. No.: US 2026/0168529 A1
(43) Pub. Date: Jun. 18, 2026

(54) Calendar for Rolling a Material Web Having a Constant Thickness, and Corresponding Method

(71) Applicants: MATTHEWS INTERNATIONAL GMBH, Vreden (DE); MATTHEWS INTERNATIONAL CORPORATION, Pittsburgh, PA (US)

(72) Inventor: Rene WOLTERS, Vreden (DE)

(21) Appl. No.: 19/500,682

(22) PCT Filed: Oct. 10, 2023
(86) PCT No.: PCT/EP2023/077953

§ 371 Date: Feb. 18, 2026

(30) Foreign Application Priority Data
Jul. 12, 2023 (DE) 10 2023 118 451.2
Sep. 26, 2023 (DE) 10 2023 126 098.7

(51) Int. Cl. F16C 13/02

(52) U.S. Cl. CPC F16C 13/02; F16C 2220/44; F16C 2229/00; F16C 2322/12

(57) ABSTRACT

The invention relates to a calender for rolling a material web, which calender has at least two rollers which are arranged in parallel next to one another and between which a roller gap is formed, wherein each roller has a roller body as well as a first bearing journal and a second bearing journal axially opposite the first, by means of which journals each roller is mounted, wherein at least an inner bearing facing the roller body and an outer bearing facing away from the roller body are arranged axially next to one another at least on a first bearing journal of a first of the rollers and an adjacent first bearing journal of a second of the rollers, so that the inner bearings are arranged in a first bearing row and the outer bearings are arranged in a second bearing row, wherein the roller gap and/or a preload between the rollers is adjusted by clamping the inner bearings in alignment with one another or the outer bearings in alignment with one another and by diagonally clamping an inner bearing to an outer bearing. The invention also relates to a corresponding method.

The invention relates to a calender for rolling a web of material with a constant thickness, comprising at least two parallel adjacent rollers, between which a roller gap is formed, wherein each roller comprises a roller barrel and a first bearing journal and a second bearing journal which is axially opposite the first and via which the respective roller is mounted, wherein at least one inner bearing which faces the roller barrel and an outer bearing which faces away from the roller barrel are arranged axially adjacent to one another at least on a first bearing journal of a first one of the rollers and on an adjacent first bearing journal of a second one of the rollers, so that the inner bearings are arranged in a first bearing row and the outer bearings are arranged in a second bearing row relative to one another.

Such a calender is known from DE 10 2019 135 524A1 . In this calender, two rollers are clamped against one another by clamping two bearings of one roller in each case with two bearings of the adjacent roller in a crosswise manner. The bearings of the second roller are in turn clamped crosswise with the bearings of the next adjacent roller. The roller gap is controlled by controlling the tensile and compressive load of the clamping. Furthermore, the gap between the rollers is adjusted via the path control of the preloading. The complexity of this construction is susceptible to faults due to the high degree of interaction between the forces acting on the bearings and requires a high technical effort with regard to gap control.

It is therefore an object of the invention to develop a calender and a corresponding method in such a way that it has a lower complexity and susceptibility to disturbances with respect to the gap control.

The object is achieved by the features of the independent claim. Advantageous embodiments of the invention are described in the dependent claims.

Accordingly, it is provided that the roller gap and/or a preloading between the rollers is set by clamping the inner bearings in alignment with one another or the outer bearings with one another on the one hand and by diagonally clamping an inner bearing with an outer bearing on the other hand. Bearings are considered to be aligned in the sense of the application when they can be assigned to a corresponding bearing of the adjacent roller essentially opposite one another. If a roller journal has a first inner bearing facing the roller barrel and a second bearing arranged axially next to it and facing away from the roller barrel, and an adjacent roller journal of an adjacent roller likewise has an inner first bearing and an outer second bearing, respectively, then the first bearings are assigned substantially opposite one another and the second bearings are assigned substantially opposite one another. This can be continued to any number of bearings per roller journal. It is irrelevant here whether the bearings are directly opposite one another, i.e. are aligned with one another in the strictly mathematical sense, or have a certain axial offset with respect to one another and are arranged, for example, only in portions overlapping one another in the axial direction of the rollers.

The advantage of the invention is that the preloading of the bearings does not take place crosswise and the individual control circuits for setting a respective roller gap between two rollers do not influence each other. The interaction takes place between the forces of the web of material, the tensile forces or gap-controlling forces and the compressive forces or preloading forces and is limited to two rollers or one roller gap.

It can be provided that the web of material is introduced as a powder into the first roller gap and is rolled in this or the subsequent roller gaps of the calender to form a web of material of homogeneous thickness and width. The powder can be, for example, an electrode precursor material.

It can be provided that the calender also has a third roller which is arranged parallel next to the second roller, wherein a further roller gap is formed between the second and third rollers. The third roller can have, corresponding to the first and/or second roller, at least one inner bearing facing the roller barrel and an axially adjacent outer bearing facing away from the roller barrel on a first bearing journal arranged adjacent to the first bearing journal of the second roller, so that the inner bearing is located in the first bearing row and the outer bearing is located in the second bearing row. It can be provided that the compressive forces acting diagonally between two bearing rows are directed exclusively in the same direction or are aligned parallel to one another when more than two rollers are present. In other words, it can be provided that a compressive force is exerted on each bearing only on one side, so that a maximum decoupling of the forces from one another is achieved.

In particular, it can be provided that the forces for the aligned clamping and for the diagonal clamping are opposed to one another.

Thus, provision can be made for a tensile load to be generated between the aligned, clamped bearings. Furthermore, it is conceivable that the roller gap can be adjusted by controlling the spacing of the bearings clamped in alignment. For this purpose, a device for generating a tensile load, for example a pneumatic or hydraulic cylinder, can be arranged in each case between the aligned clamped bearings. Thus, provision can be made for a tensile load to be generated between the aligned, clamped bearings. In this case, it is conceivable for the roller gap to be adjustable by controlling the spacing of the bearings clamped in alignment, in that a device for generating a compressive load, for example a pneumatic or hydraulic cylinder, is arranged in each case between the bearings clamped in alignment.

Furthermore, it can be provided that a compressive load is generated between the diagonally clamped bearings in order to generate a preload. For this purpose, a device for generating a compressive load, for example a pneumatic or hydraulic cylinder, can be arranged in each case between the diagonally clamped bearings for generating the preload. Furthermore, it can be provided that a compressive load is generated between the diagonally clamped bearings in order to generate a preload. For this purpose, a device for generating a tensile load, for example a pneumatic or hydraulic cylinder, can be arranged in each case between the diagonally clamped bearings for generating the preload. In particular, it can be provided that the diagonally clamped bearings are clamped in the opposite direction with respect to the aligned clamped bearings

In order to set a constant roller gap width between each two adjacent rollers, the ratio between a compressive force of the web of material acting in the roller gap, the tensile or compressive force of the bearings clamped in alignment with one another and the tensile or compressive force of the bearings clamped diagonally with one another can be controlled. The tensile or compressive force of the bearings clamped diagonally to one another can be constant, for example, and the compressive force of the web of material can be compensated exclusively by the tensile or compressive force which can be set by means of the bearings clamped in alignment.

Thus, it can be provided that a tensile load is generated between the inner bearing of the first roller and the inner bearing of the second roller as well as the inner bearing of the second roller and the inner bearing of the third roller, and a compressive load is generated between the inner bearing of the first roller and the outer bearing of the second roller, and a compressive load is generated between the inner bearing of the second roller and the outer bearing of the third roller. Alternatively it can be provided that a compressive load is generated between the inner bearing of the first roller and the inner bearing of the second roller as well as the inner bearing of the second roller and the inner bearing of the third roller, and a tensile load is generated between the inner bearing of the first roller and the outer bearing of the second roller, and a tensile load is generated between the inner bearing of the second roller and the outer bearing of the third roller.

The rollers can be supported on a machine frame and can be arranged on the latter so as to be displaceable relative to one another perpendicularly to the axial direction. The machine frame can have, for example, two opposite rails on which the rollers or the roller bearings can be displaced horizontally perpendicularly to the axial direction.

It can be provided that at least one further, third bearing is arranged on each of the bearing journals of the rollers, said third bearing being arranged on the outside axially next to the second bearing, so that the third bearings are arranged in a third bearing row relative to one another axially next to the second bearing row.

In this case, the bearings of two of the three bearing rows can be clamped in alignment with one another and, between two adjacent rollers, in each case one bearing of a remaining bearing row which is not clamped in alignment can be clamped diagonally with both bearings of the adjacent roller which are clamped in alignment.

Furthermore, it is conceivable that the bearings of the first bearing row are clamped in alignment with one another and the bearings of the third bearing row are clamped in alignment with one another and, between two adjacent rollers, in each case a middle bearing of the second row of a roller is diagonally clamped to the first and the third bearing of the adjacent roller.

Furthermore, at least one further, fourth bearing can be arranged on the bearing journals of the rollers, which is arranged on the outside axially next to the third bearing, so that the fourth bearings are arranged in a fourth bearing row relative to one another next to the third bearing row.

If four bearings are present per bearing journal, the bearings of two of the four bearing rows can be clamped in alignment with one another and, between two adjacent rollers, a bearing of a first remaining bearing row which is not clamped in alignment can be clamped diagonally with a bearing of a first of the bearing rows of the adjacent roller which are clamped in alignment. Furthermore, a bearing of a second remaining bearing row which is not clamped in alignment can be diagonally clamped to a bearing of a second of the bearing rows of the adjacent roller which are clamped in alignment.

In a first configuration, the bearings of the second bearing row can be clamped in alignment with one another and the bearings of the fourth bearing row can be clamped in alignment with one another. Between two rollers, a bearing of the first bearing row of a first of the adjacent rollers can be diagonally clamped with a bearing of the second bearing row of the adjacent roller and, furthermore, a bearing of the third bearing row of the first of the adjacent rollers can be diagonally clamped with a bearing of the fourth bearing row of the adjacent roller.

In a second configuration, the bearings of the first bearing row can be clamped in alignment with one another and the bearings of the fourth bearing row can be clamped in alignment with one another. Between two rollers, a bearing of the second bearing row of a first of the adjacent rollers can be diagonally clamped with a bearing of the first bearing row of the adjacent roller and a bearing of the third bearing row of the first adjacent roller can be diagonally clamped with a bearing of the fourth bearing row of the adjacent roller.

The invention further relates to a method for controlling the gap width of a calender for producing a web of material of constant thickness, preferably with a calender according to any one of the preceding claims, comprising the steps of:
providing a calender comprising at least two parallel adjacent rollers, between which a roller gap is formed,
wherein each roller comprises a roller barrel and a first bearing journal and a second bearing journal, which is axially opposite the first bearing journal, via which the respective roller is mounted, wherein at least one inner bearing facing the roller barrel and an outer bearing facing away from the roller barrel are arranged axially next to one another at least on a first bearing journal of a first one of the rollers and on an adjacent first bearing journal of a second one of the rollers, so that the inner bearings are arranged in a first bearing row and the outer bearings are arranged in a second bearing row,
adjusting a roller gap width and/or preload between the rollers by clamping the inner bearings or the outer bearings in alignment with one another, on the one hand, and by diagonally clamping an inner bearing with an outer bearing, on the other hand;
rolling a web of material in the roller gap;
controlling a constant roller gap width by determining the compressive force of the web of material acting in the gap, adjusting the preloading force of the bearings clamped in alignment with one another and/or the preloading force of the bearings clamped diagonally with one another as a function of the determined compressive force of the web of material.

It can be provided that the control of the constant roller gap width comprises the adjustment of the preloading force of the bearings clamped in alignment with one another as a function of the determined compressive force of the web of material, the preloading force of the bearings clamped diagonally with one another being constant. It is conceivable that a tensile force is generated between the bearings clamped in alignment with one another and a compressive force is generated between the bearings clamped diagonally with one another. Alternatively it is conceivable that a compressive force is generated between the bearings clamped in alignment with one another and a tensile force is generated between the bearings clamped diagonally with one another.

At least one further, third bearing can arranged on each of the first bearing journals of the rollers, said third bearing being arranged on the outside axially next to the second bearing, so that the third bearings are arranged in a third bearing row relative to one another axially next to the second bearing row.

The method can further comprise the aligned clamping of the bearings of two of the three bearing rows and the diagonal clamping of a bearing of the remaining, not aligned clamped bearing row with both aligned clamped bearings of the adjacent roll.

Furthermore, the method can provide that the bearings of the first bearing row are clamped in alignment with one another and the bearings of the third bearing row are clamped in alignment with one another and between two rollers in each case one bearing of the second bearing row is in each case diagonally clamped with the bearings of the first and the third bearing row of the adjacent roller.

Furthermore, at least one further, fourth bearing can be arranged on the bearing journals of the rollers, which is arranged on the outside axially next to the third bearing, so that the fourth bearings are arranged in a fourth bearing row relative to one another next to the third bearing row.

In addition, the aligned clamping of the bearings of two of the four bearing rows and the diagonal clamping of a bearing of one bearing of the remaining, not aligned clamped bearing rows with a first of the aligned clamped bearings of the adjacent roller can be provided. Furthermore, the diagonal clamping of a bearing of the other remaining, non-aligned clamped bearing row with a second of the aligned clamped bearings of the adjacent roller can be provided.

In a first configuration, the method can further comprise clamping the bearings of the second bearing row in alignment with one another and clamping the bearings of the fourth bearing row in alignment with one another. Furthermore a diagonal clamping of a respective bearing of the first bearing row of a first one of the adjacent rollers with a bearing of the second bearing row of the adjacent roller and a diagonal clamping of a bearing of the third bearing row of the first one of the adjacent rollers with a bearing of the fourth bearing row of the adjacent roller can be provided.

Alternatively the method in a second configuration can further comprise clamping the bearings of the first bearing row in alignment with one another and clamping the bearings of the fourth bearing row in alignment with one another. For this purpose, a diagonal clamping of a respective bearing of the second bearing row of a first one of the adjacent rollers with a bearing of the first bearing row of the adjacent roller can be performed and a diagonal clamping of a bearing of the third bearing row of the first one of the adjacent rollers with a bearing of the fourth bearing row of the adjacent roller can take place.

It can be provided that the calender has a third roller which is arranged parallel next to the second roller, wherein a further roller gap is formed between the second and third rollers. The third roller can also have at least one inner bearing facing the roller barrel and an axially adjacent outer bearing facing away from the roller barrel on a first bearing journal arranged adjacent to the first bearing journal of the second roller, so that the inner bearing is located in the first bearing row and the outer bearing is located in the second bearing row. The method may also comprise the following steps:
driving adjacent rollers in opposite directions and/or guiding the web of material first through the first roller gap and then through the second roller gap. By driving the rollers in opposite directions, the material to be rolled can first be fed into the first roller gap from a first direction, then the web of material produced runs around the, for example, middle roller following the rotation of the roller and is guided through the second roller gap in the direction opposite to the first direction.

It can be provided that the third roller on the first roller journal also has a third bearing which is arranged axially next to the side of the second bearing facing away from the roller barrel and is located in the third bearing row. Furthermore, the third roller on the first roller journal can also have a fourth bearing, which is arranged axially next to the side of the third bearing facing away from the roller barrel and is located in the fourth bearing row.

Further details of the invention are explained using the figures below. In particular:

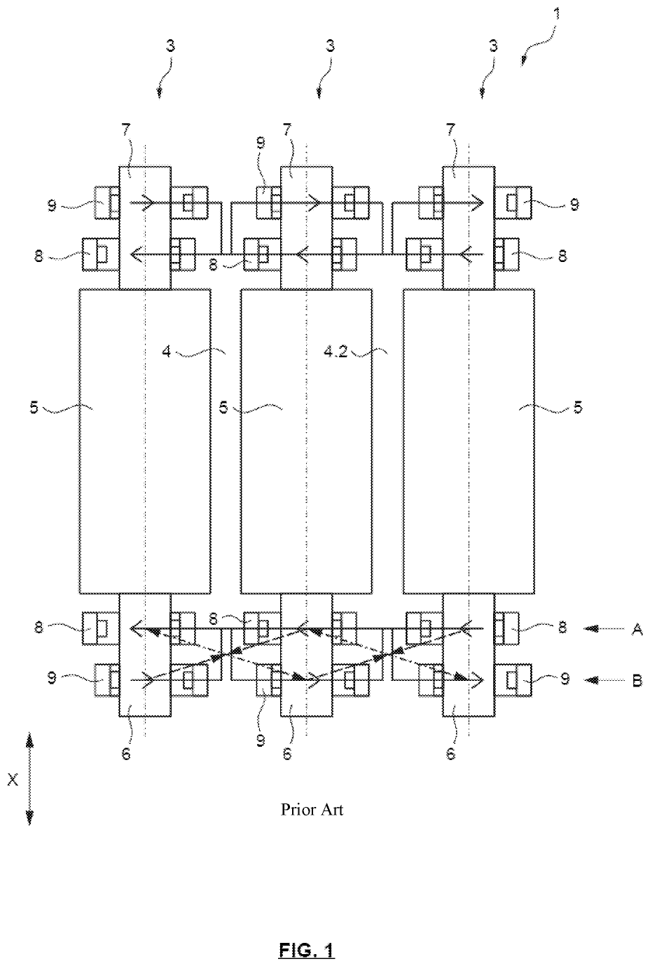

FIG. 1 shows a calender known from the prior art with a representation of the flow of force in the case of mutually clamped rollers with two bearings;

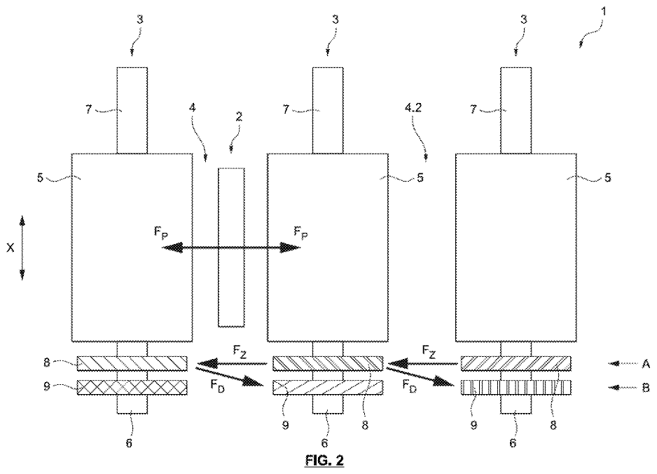

FIG. 2 shows a plan view of a calender with three rollers each with two bearings and the forces acting on the bearings according to a first embodiment of the invention;

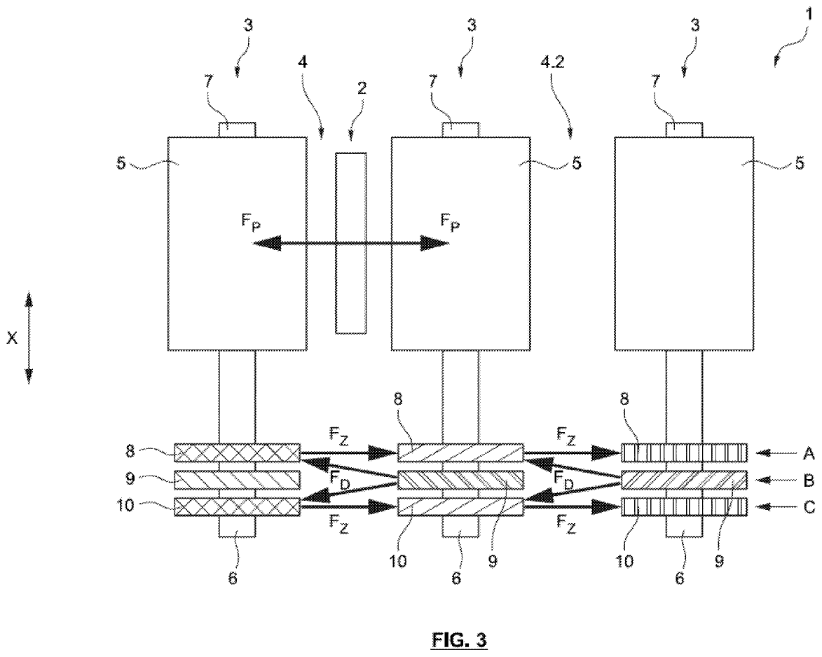

FIG. 3 shows a plan view of a calender with three rollers each with three bearings and the forces acting on the bearings according to a second embodiment of the invention;

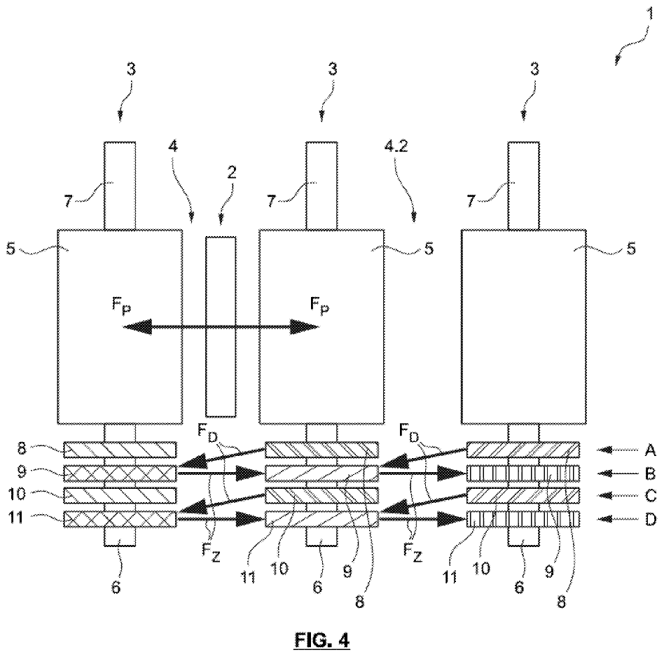

FIG. 4 shows a plan view of a calender with three rollers each with four bearings and the forces acting on the bearings according to a third embodiment of the invention;

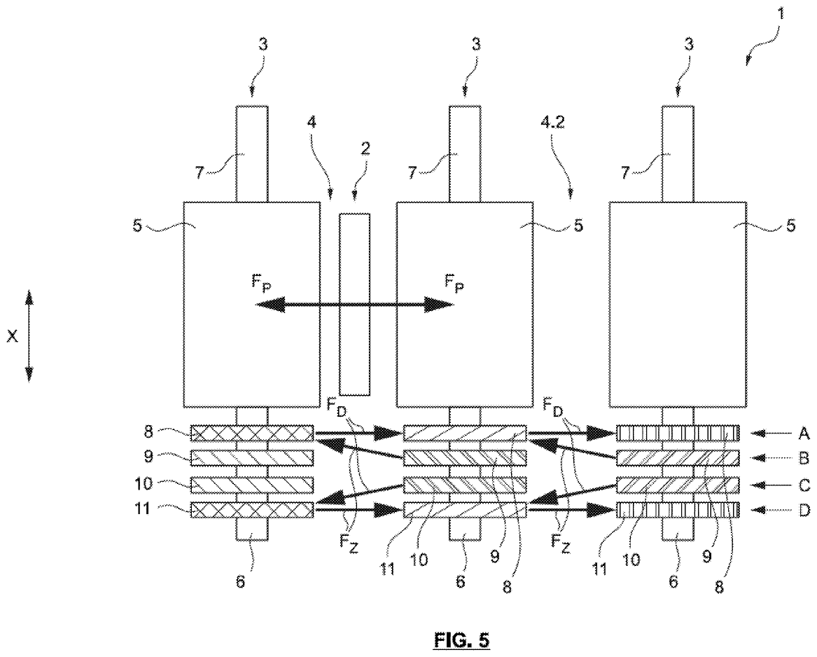

FIG. 5 shows a plan view of a calender with three rollers each with four bearings and the forces acting on the bearings according to a fourth embodiment of the invention;

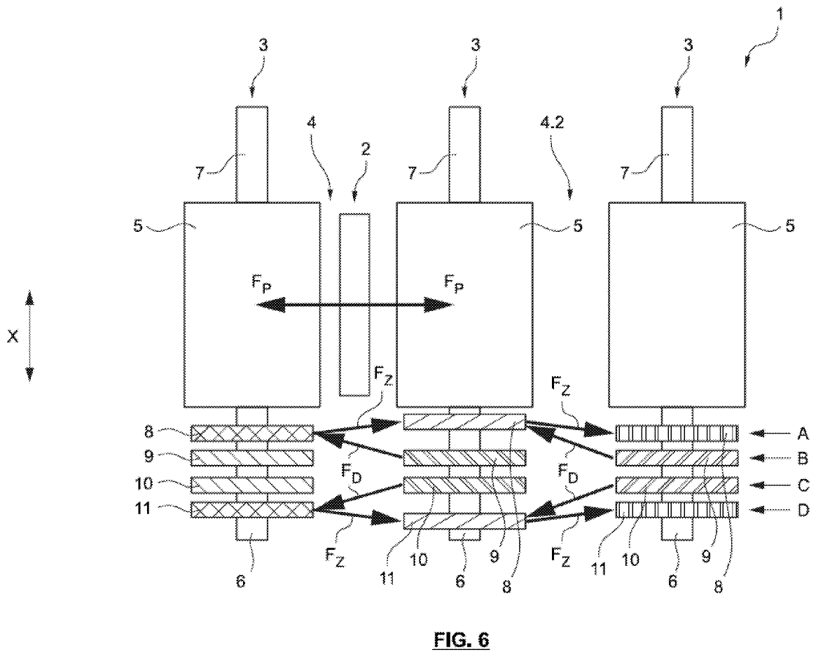

FIG. 6 shows a plan view of a calender with three rollers each with four bearings and the forces acting on the bearings according to a fifth embodiment of the invention;

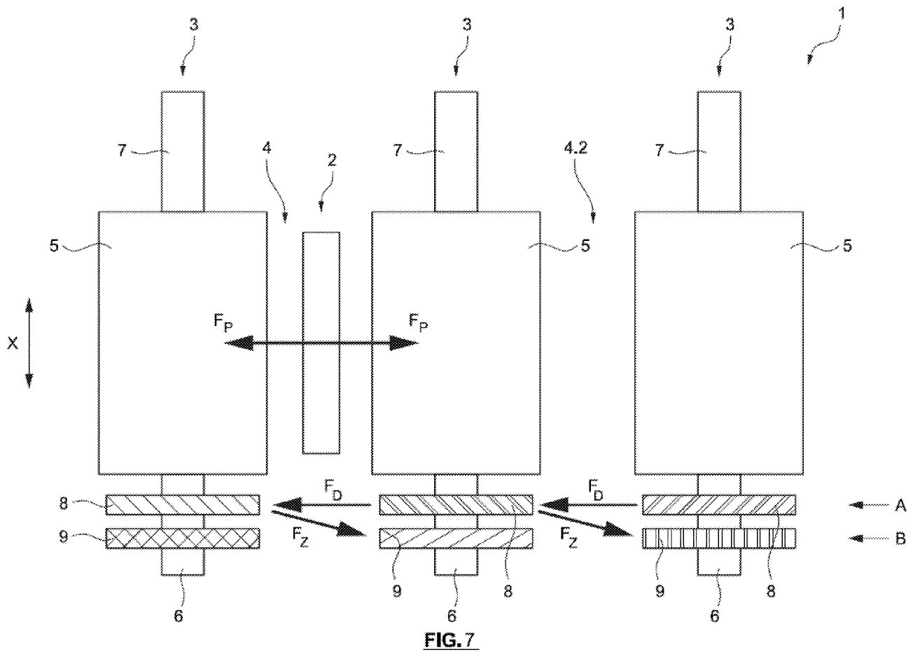

FIG. 7 shows a plan view of a calender with three rollers each with two bearings and the forces acting on the bearings according to a sixth embodiment of the invention;

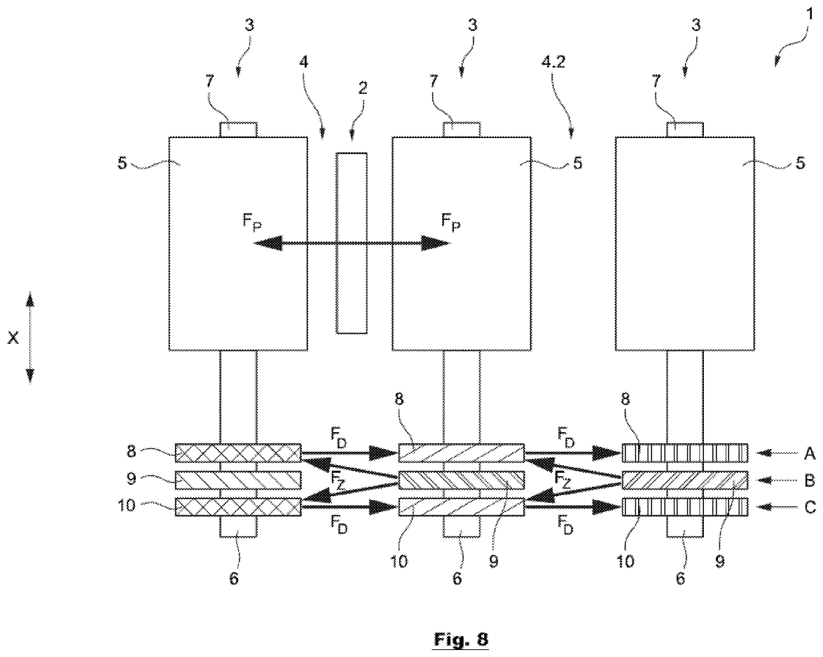

FIG. 8 shows a plan view of a calender with three rollers each with three bearings and the forces acting on the bearings according to a seventh embodiment of the invention;

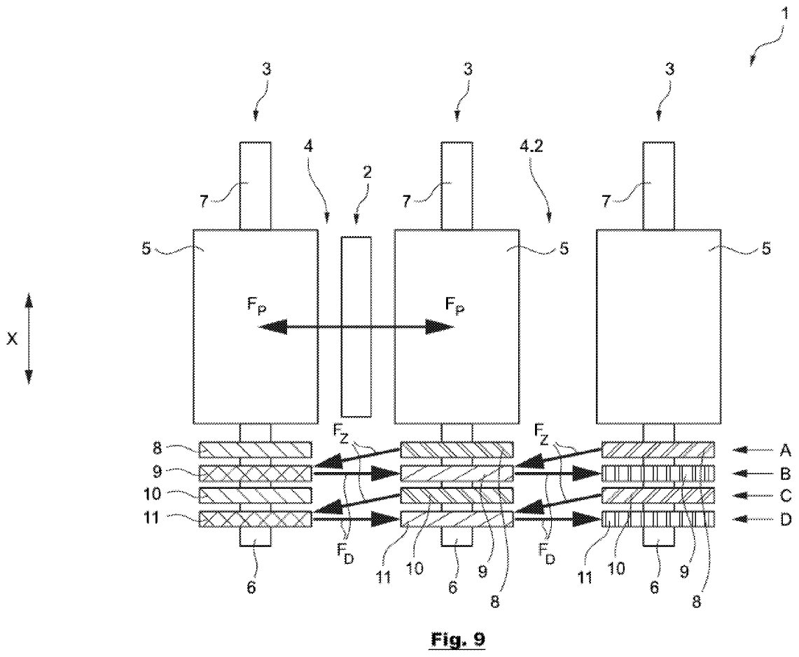

FIG. 9 shows a plan view of a calender with three rollers each with four bearings and the forces acting on the bearings according to an eighth embodiment of the invention;

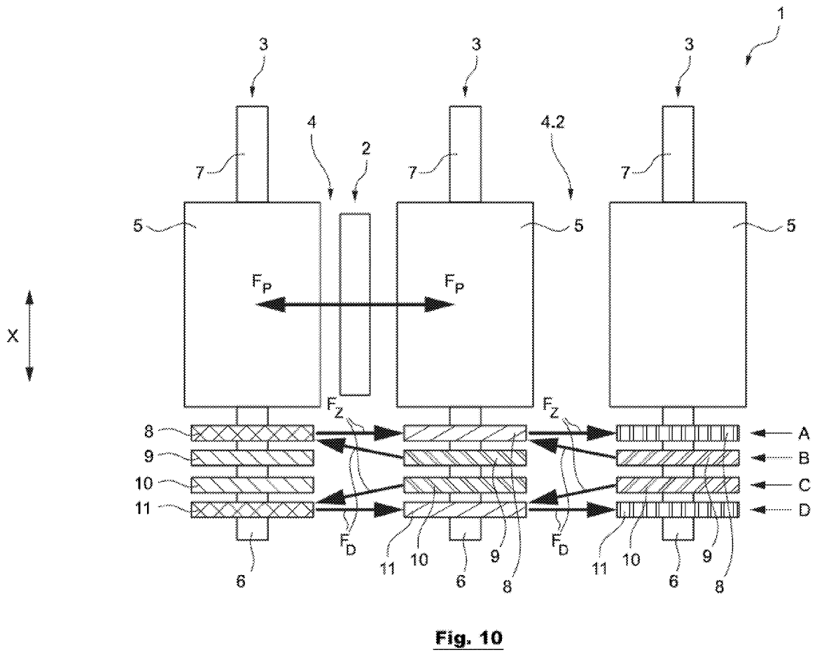

FIG. 10 shows a plan view of a calender with three rollers each with four bearings and the forces acting on the bearings according to a ninth embodiment of the invention;

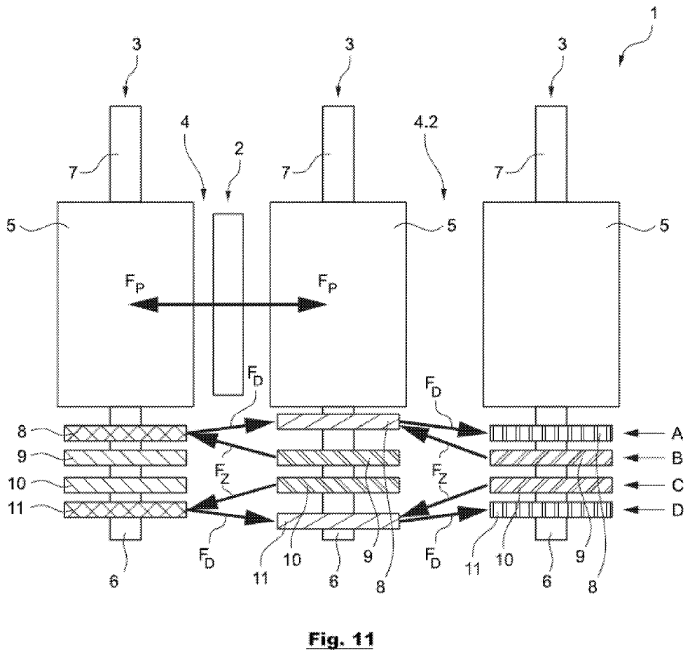

FIG. 11 shows a plan view of a calender with three rollers each with four bearings and the forces acting on the bearings according to a tenth embodiment of the invention;

FIG. 1 shows a calender 1 known from the prior art, with three parallel rollers 3 arranged next to one another, between which rollers a roller gap 4, 4.2 is formed in each case. Each of the rollers 3 has a roller barrel 5 as well as a first bearing journal 6 and a second bearing journal 7 which is axially opposite the first and by means of which the respective roller 3 is mounted. An inner bearing 8 facing the roller barrel 5 and an outer bearing 9 facing away from the roller barrel 5 are respectively provided on the bearing journals 6, 7, the bearings 8, 9 being arranged axially next to one another, so that the inner bearings 8 are arranged in a first bearing row A and the outer bearings 9 are arranged in a second bearing row B with respect to one another. The rollers are clamped against one another by clamping two bearings 8, 9 of a roller 3 in each case with two bearings 8, 9 of the adjacent roller 3 in a crosswise manner. The bearings 8, 9 of the second roller 3 are in turn clamped crosswise with the bearings 8, 9 of the next adjacent roller 3. As can be seen, the inner bearing 8 of a left-hand roller 3 is clamped at the lower roller journals 6 with the outer bearing 9 of a roller 3 located to the right of the roller 3 by means of a compressive load. At the same time, the respective outer bearing 9 of a left-hand roller 3 is clamped with the inner bearing 8 of the roller 3 located to the right of the roller 3 by means of a tensile load. It is clear from this that, in order to control each roller gap 4, 4.2 or the preload provided therein, a large number of forces must be taken into account, or that there is a large interaction between the forces, in addition, the forces occurring in the roller gaps 4, 4.2, which are generated by the rolling of the web of material 2, must also be taken into account. The complexity of this construction is susceptible to faults due to the high degree of interaction between the forces acting on the bearings and requires a high technical effort with regard to gap control.

FIG. 2 shows a first embodiment of the calender 1 according to the invention. In this arrangement, a respective roller 3 is equipped with two bearings 8, 9 on the roller journal 6, 7. By way of example, the rolling of a web of material 2 is shown, which is rolled in the roller gap 4 and exerts the compressive force F_{P} on the latter. The same applies to the second roller gap 4.2 as soon as the web of material 2 is passed through it (not shown). As can be seen, the inner bearings 8 are clamped to one another in alignment, i.e. lying in the row A, a tensile load F_{Z} being generated between the individual bearings 8. In contrast, the inner bearing 8 of the left-hand roller 3 is clamped diagonally with the outer bearing 9 of the middle roller 3 by means of a compressive load F_{D}, and the inner bearing 8 of the middle roller 3 is clamped diagonally with the outer bearing 9 of the right-hand roller 3 by means of a compressive load F_{D}. The outer bearing 9 of the left-hand roller 3 is not acted upon by any force on the part of the middle roller 3. A corresponding arrangement (not shown) is provided on the opposite roller journals 7. The roller spacing is adjusted via the inner bearings 8 and the forces F_{Z} associated therewith and counteracts the force of the web of material. The preload between the left-hand roller 3 of the middle roller 3 is generated via a hydraulic cylinder (not shown) between the inner bearing 8 of the left-hand roller 3 and the outer bearing 9 of the middle roller. A corresponding arrangement is found between the middle and the right-hand roller 3. Bearings which are acted upon by a compressive load are in each case acted upon by a compressive load F_{D} only from one side, so that maximum force decoupling is achieved. The inner bearing 8 of the left-hand roller 3 and the inner bearing 8 of the middle roller 3 are subject to pressure only from the right, the outer bearing 9 of the middle roller 3 and the outer bearing 9 of the right-hand roller 3 are accordingly subject to pressure only from the left. Thus, the preloading is not generated crosswise, so that the individual control circuits of the different rollers do not influence each other. The interaction takes place only between the forces of the web of material F_{P}, the tensile load F_{Z} or gap control and the compressive load F_{D} or preload and is limited to two rollers 3 or one roller gap 4, 4.2. This complexity can be further reduced by operating the preload at constant force and compensating the force F_{P} of the web of material 2 by means of the gap control F_{Z}. In this way, a web of material 2 of constant thickness can be produced.

The second embodiment of the invention shown in FIG. 3 has the essential difference from the arrangement of FIG. 1 that three bearings 8, 9, 10 are provided per roller journal 6, 7, which have a different clamping configuration. Thus, an inner bearing row A, a middle bearing row B and an outer bearing row C are formed. In the three-bearing arrangement, the gap force or the gap width is controlled by aligned clamping (tensile force F_{Z}) of the outer and inner bearings 8, 10 or of the bearing rows A and C. The middle bearing 9 is connected in each case on one side (shown on the left) to the outer and the inner bearing 8, 10 of the adjacent roller (on the left) and builds up the preload (compressive force F_{D}) with respect to these bearings. The middle bearing 9 of the left-hand roller 3 is not subject to force by the middle roller 3. Bearings which are acted upon by a compressive load are in each case acted upon by a compressive load F_{D} only from one side, so that maximum force decoupling is achieved. The inner bearings 8 and outer bearings 10 of the left-hand and the middle roller 3 are subject to pressure only from the right, the middle bearings 9 of the middle and the right-hand roller 3 are subject to pressure accordingly only from the left. In the case of the three-bearing arrangement, an imbalance arises in the roller journals 6, 7, since two bearings 8, 10 are preloaded in one direction and one bearing 9 is preloaded in the opposite direction. This leads to an additional load on the middle bearing 9. In order to avoid this additional load, a four-bearing or multi-bearing arrangement is conceivable.

FIG. 4 and FIG. 5 show a third and a fourth embodiment of the invention, which has a 4-bearing arrangement, so that four bearings 8, 9, 10, 11 are provided on each bearing journal 6, 7, arranged axially next to one another, the inner bearings 8 being arranged in a first bearing row A, the second bearings from the inside 9 being arranged in a second bearing row B, the third bearings from the inside 10 being arranged in a third bearing row 10 and the outer (fourth bearings from the inside) bearings 11 being arranged in a bearing row D. The third and fourth embodiments again differ in that the clamping configuration of the bearings 8, 9, 10, 11 is different. In the third embodiment, the bearing rows B and D are clamped in alignment with one another (tensile force F_{Z}). In contrast, the first bearings 8 are each preloaded diagonally with a second bearing 9 of the roller 3 adjacent to the left by means of a compressive force F_{D} and the third bearings 10 are preloaded diagonally with a fourth bearing 11 of the roller 3 adjacent to the left by means of a compressive force F_{D}. The first and third bearings 8, 10 of the left-hand roller 3 are not subjected to such a force. Bearings which are acted upon by a compressive load are in each case acted upon by a compressive load F_{D} only from one side, so that maximum force decoupling is achieved. The second bearings 9 and outer bearings 11 of the left-hand and middle roller 3 are subject to pressure only from the right, the first bearings 8 and third bearings 10 of the middle and right-hand roller 3 are subject to pressure accordingly only from the left.

In the fourth embodiment (FIG. 5), on the other hand, the first bearing row A and the fourth bearing row D are clamped in alignment (tensile force F_{Z}), whereas in each case the second bearing 9 of a roller 3 is clamped to the first bearing 8 of the roller 3 located to the left thereof and the third bearing 10 of the roller 3 is clamped to the fourth bearing 11 of the roller located to the left thereof (compressive force F_{D}). Bearings which are acted upon by a compressive load are in each case acted upon by a compressive load F_{D} only from one side, so that maximum force decoupling is achieved. The first bearing 8 and fourth bearings 11 of the left-hand and middle roller 3 are subject to pressure only from the right, the second bearings 9 and third bearings 10 of the middle and right-hand roller 3 are subject to pressure accordingly only from the left. The fourth embodiment has the advantage that the resulting force of the preload in the axial direction X is zero, since the above-described compressive forces F_{D} cancel each other out in the axial direction X. These bearing arrangements can be used for any number of bearings per roller journal and for calenders with any number of rollers.

FIG. 6 shows a fifth embodiment of the invention, which differs from the fourth embodiment of FIG. 5 only in that the bearing 8 of the middle roller 3 is displaced axially inward and the bearing 11 of the middle roller 3 is displaced axially outward, with respect to the adjacent inward and outward bearings 8 and 11 of the adjacent rollers. Nevertheless, the bearings 8 of the first bearing row A and the bearings 11 of the fourth bearing row D form a respective alignment with one another in the sense of the application, since these are in each case substantially opposite one another and are functionally associated with one another. The bearings 8 of bearing row A and the bearings 11 of bearing row D are accordingly each clamped in alignment with one another.

FIG. 7 shows a sixth embodiment of the calender 1 according to the invention. In this arrangement, a respective roller 3 is equipped with two bearings 8, 9 on the roller journal 6, 7. By way of example, the rolling of a web of material 2 is shown, which is rolled in the roller gap 4 and exerts the compressive force F_{P} on the latter. The same applies to the second roller gap 4.2 as soon as the web of material 2 is passed through it (not shown). As can be seen, the inner bearings 8 are clamped to one another in alignment, i.e. lying in the row A, a compressive load F_{P} being generated between the individual bearings 8. In contrast, the inner bearing 8 of the left-hand roller 3 is clamped diagonally with the outer bearing 9 of the middle roller 3 by means of a tensile load F_{Z} , and the inner bearing 8 of the middle roller 3 is clamped diagonally with the outer bearing 9 of the right-hand roller 3 by means of a tensile load F_{Z}. The outer bearing 9 of the left-hand roller 3 is not acted upon by any force on the part of the middle roller 3. A corresponding arrangement (not shown) is provided on the opposite roller journals 7. The roller spacing is adjusted via the inner bearings 8 and the forces F_{D} associated therewith and counteracts the force of the web of material. The preload between the left-hand roller 3 of the middle roller 3 is generated via a hydraulic cylinder (not shown) between the inner bearing 8 of the left-hand roller 3 and the outer bearing 9 of the middle roller. A corresponding arrangement is found between the middle and the right-hand roller 3. Bearings which are acted upon by a tensile load are in each case acted upon by a tensile load F_{Z} only from one side, so that maximum force decoupling is achieved. The inner bearing 8 of the left-hand roller 3 and the inner bearing 8 of the middle roller 3 are subject to pressure only from the right, the outer bearing 9 of the middle roller 3 and the outer bearing 9 of the right-hand roller 3 are accordingly subject to pressure only from the left. Thus, the preloading is not generated crosswise, so that the individual control circuits of the different rollers do not influence each other. The interaction takes place only between the forces of the web of material F_{P} , the compressive load F_{D} or gap control and the tensile load F_{Z} or preload and is limited to two rollers 3 or one roller gap 4, 4.2. This complexity can be further reduced by operating the preload at constant force and compensating the force F_{P} of the web of material 2 by the gap control F_{D}. In this way, a web of material 2 of constant thickness can be produced.

The second embodiment of the invention shown in FIG. 8 has the essential difference from the arrangement of FIG. 1 that three bearings 8, 9, 10 are provided per roller journal 6, 7, which have a different clamping configuration. Thus, an inner bearing row A, a middle bearing row B and an outer bearing row C are formed. In the three-bearing arrangement, the gap force or the gap width is controlled by aligned clamping (compressive force F_{D}) of the outer and inner bearings 8, 10 or of the bearing rows A and C. The middle bearing 9 is connected in each case on one side (shown on the left) with the outer and the inner bearing 8, 10 of the adjacent roller (on the left) and builds up the preload (tensile force F_{Z}) with respect to these bearings. The middle bearing 9 of the left-hand roller 3 is not subject to force by the middle roller 3. Bearings which are acted upon by a tensile load are in each case acted upon by a tensile load F_{Z} only from one side, so that maximum force decoupling is achieved. The inner bearings 8 and outer bearings 10 of the left-hand and the middle roller 3 are subject to pressure only from the right, the middle bearings 9 of the middle and the right-hand roller 3 are subject to pressure accordingly only from the left. In the case of the three-bearing arrangement, an imbalance arises in the roller journals 6, 7, since two bearings 8, 10 are preloaded in one direction and one bearing 9 is preloaded in the opposite direction. This leads to an additional load on the middle bearing 9. In order to avoid this additional load, a four-bearing or multi-bearing arrangement is conceivable.

FIG. 9 and FIG. 10 show an eighth and ninth embodiment of the invention, which has a 4-bearing arrangement, so that four bearings 8, 9, 10, 11 arranged axially next to one another are provided on each bearing journal 6, 7, the inner bearings 8 being arranged in a first bearing row A, the second bearings from the inside 9 being arranged in a second bearing row B, the third bearings from the inside 10 being arranged in a third bearing row 10 and the outer (fourth bearings from the inside) bearings 11 being arranged in a bearing row D. The third and fourth embodiments again differ in that the clamping configuration of the bearings 8, 9, 10, 11 is different. In the third embodiment, the bearing rows B and D are clamped in alignment with one another (compressive force F_{D}). In contrast, the first bearings 8 are each preloaded diagonally with a second bearing 9 of the roller 3 adjacent to the left by means of a tensile force F_{Z} and the third bearings 10 are preloaded diagonally with a fourth bearing 11 of the roller 3 adjacent to the left by means of a tensile force F_{Z}. The first and third bearings 8, 10 of the left-hand roller 3 are not subjected to such a force. Bearings which are acted upon by a tensile load are in each case acted upon by a tensile load F_{Z} only from one side, so that maximum force decoupling is achieved. The second bearings 9 and outer bearings 11 of the left-hand and middle roller 3 are subject to tension only from the right, the first bearings 8 and third bearings 10 of the middle and right-hand roller 3 are subject to tension accordingly only from the left.

In the ninth embodiment (FIG. 10), on the other hand, the first bearing row A and the fourth bearing row D are clamped in alignment (compressive force F_{D}), whereas in each case the second bearing 9 of a roller 3 is clamped to the first bearing 8 of the roller 3 located to the left thereof and the third bearing 10 of the roller 3 is clamped to the fourth bearing 11 of the roller located to the left thereof (tensile force F_{Z}). Bearings which are acted upon by a tensile load are in each case acted upon by a tensile load F_{Z} only from one side, so that maximum force decoupling is achieved. The first bearings 8 and fourth bearings 11 of the left-hand and middle roller 3 are subject to tension only from the right, the second bearings 9 and third bearings 10 of the middle and right-hand roller 3 are subject to tension accordingly only from the left. The ninth embodiment has the advantage that the resulting force of the preload in the axial direction X is zero, since the above-described tensile forces F_{Z} cancel each other out in the axial direction X. These bearing arrangements can be used for any number of bearings per roller journal and for calenders with any number of rollers.

FIG. 11 shows a tenth embodiment of the invention, which differs from the ninth embodiment of FIG. 10 only in that the bearing 8 of the middle roller 3 is displaced axially inward and the bearing 11 of the middle roller 3 is displaced axially outward, with respect to the adjacent inward and outward bearings 8 and 11 of the adjacent rollers. Nevertheless, the bearings 8 of the first bearing row A and the bearings 11 of the fourth bearing row D form a respective alignment with one another in the sense of the application, since these are in each case substantially opposite one another and are functionally associated with one another. The bearings 8 of bearing row A and the bearings 11 of bearing row D are accordingly each clamped in alignment with one another.

The features of the invention disclosed in the above description, in the figures, and in the claims can be essential for the implementation of the invention both individually and in any combination.

### LIST OF REFERENCE NUMERALS

1 calender
2 web of material
3 roller
4 roller gap
4.2 second roller gap
5 roller barrel
6 first bearing journal
7 second bearing journal
8 inner (first) bearing
9 outer (second) bearing
10 third bearing
11 fourth bearing
A first bearing row
B second bearing row
C third bearing row
D fourth bearing row
F_{D} compressive force
F_{Z} tensile force
F_{P} compressive force on material web
X axial direction

1. A calender (1) for rolling a web of material (2) with a constant thickness, having at least two rollers (3) arranged parallel next to one another, between which rollers a roller gap (4) is formed, wherein each roller (3) has a roller barrel (5) and a first and a second bearing journal (6, 7) which second bearing journal is axially opposite the first and via which the respective roller (3) is mounted,
wherein, at least on a first bearing journal (6) of a first of the rollers (3) and on an adjacent first bearing journal (6) of a second of the rollers (3), in each case at least one inner bearing (8) facing the roller barrel (5) and an outer bearing (9) facing away from the roller barrel (5) are arranged axially adjacent to one another, so that the inner bearings (8) are arranged in a first bearing row (A) and the outer bearings (9) are arranged in a second bearing row (B) relative to one another,
characterized in that the roller gap (4) and/or a preload between the rollers (3) is adjusted by aligned clamping of the inner bearings (8) relative to one another or of the outer bearings (9) relative to one another, on the one hand, and by diagonal clamping of an inner bearing (8) with an outer bearing (9), on the other hand.

2. The calender (1) according to claim 1, which also has a third roller (3) which is arranged parallel to the second roller (3), wherein a further roller gap (4) is formed between the second and third rollers (3), wherein the third roller (3) has, on a first bearing journal (6) arranged adjacent to the first bearing journal (6) of the second roller (3), at least one inner bearing (8) which faces the roller barrel (5) and an outer bearing (9) which is arranged axially next to it and faces away from the roller barrel (5), so that the inner bearing (8) lies in the first bearing row (A) and the outer bearing (9) lies in the second bearing row (B).

3. The calender according to any one of claim 1, in which the forces for aligned clamping and for diagonal clamping are opposite one another.

4. The calender according to any one of claim 1, in which a tensile load or a compressive load (F_{Z} , F_{D}) is produced in each case between the bearings (8, 9) which are clamped in alignment.

5. The calender according to any one of claim 1, in which the roller gap (4) can be adjusted by controlling the spacing of the bearings (8, 9) which are in each case clamped in alignment with one another.

6. The calender (1) according to claim 4, in which a device (12) for generating a tensile or a compressive load (F_{Z}, F_{D}), for example a pneumatic or hydraulic cylinder, is arranged in each case between the bearings (8, 9) which are clamped in alignment with one another.

7. The calender (1) according to any one of claim 1, wherein a compressive or a tensile load (F_{Z}, F_{D}) is produced in each case between the diagonally clamped bearings (8, 9) for producing a preload, and the diagonally clamped bearings (8, 9) are clamped in the opposite direction with respect to the aligned clamped bearings (8, 9).

8. The calender (1) according to claim 7, in which a device (13) for generating a tensile or compressive load (F_{D}), for example a pneumatic or hydraulic cylinder, is arranged in each case between the diagonally clamped bearings (8, 9) for generating a preload.

9. The calender (1) according to claim 1, in which, in order to set a constant roller gap width between respective two adjacent rollers (3), the ratio between a compressive force (F_{P}) of the web of material (2) acting in the roller gap (4), the preloading force (F_{Z}) of the bearings clamped in alignment with one another, and the preloading force (F_{D}) of the bearings (3) clamped diagonally with one another is controlled.

10. The calender (1) according to claim 9, in which the preloading force (F_{D}) of the bearings (3) clamped diagonally with one another is constant and the compressive force (F_{P}) of the web of material (2) is compensated for by the preloading force (F_{Z}) which can be set by means of the bearings (8, 9) clamped in alignment.

11. The calender (1) according to any one of claim 7, in which a tensile or a compressive load (F_{Z}) is generated between the inner bearing (8) of the first roller (3) and the inner bearing (8) of the second roller (3) and the inner bearing (8) of the second roller (3) and the inner bearing (3) of the third roller (3), and a tensile or a compressive load (F_{D}) is generated between the inner bearing (8) of the first roller (3) and the outer bearing (9) of the third roller (3), and a tensile or a compressive load (F_{D}) is generated between the inner bearing (8) of the second roller (3) and the outer bearing (9) of the third roller (3).

12. The calender (1) according to claim 1, in which the rollers (3) are supported on a machine frame (14) and are arranged so as to be displaceable relative to one another perpendicularly to the axial direction (X).

13. The calender (1) according to claim 1, in which in each case at least one further, third bearing (10) is arranged on the bearing journals (6, 7) of the rollers, which third bearing is arranged axially on the outside next to the second bearing (9), so that the third bearings (10) are arranged in a third bearing row (C) relative to one another axially next to the second bearing row (B).

14. The calender according to claim 13, in which the bearings (8, 9, 10) of two of the three bearing rows (A, B, C) are clamped in alignment with one another, and wherein, between two adjacent rollers (3), in each case one bearing (8, 9, 10) of a remaining bearing row (A, B, C), which is clamped in non-aligned manner, is diagonally clamped to both bearings (8, 9, 10) clamped in alignment of the adjacent roller (3).

15. The calender (1) according to claim 14, in which the bearings (8) of the first bearing row (A) are clamped in alignment with one another and the bearings (10) of the third bearing row (C) are clamped in alignment with one another, and a respective middle bearing (9) of the second row (B) of a roller (3) is clamped diagonally with the first and the third bearing (8, 10) of the adjacent roller (3) between two adjacent rollers (3).

16. The calender (1) according to any one of claim 14, in which at least one further fourth bearing (11) is also arranged on each of the bearing journals (6, 7) of the rollers (3), which bearing is arranged axially on the outside next to the third bearing (10), so that the fourth bearings (11) are arranged in a fourth bearing row (D) in relation to one another next to the third bearing row (C).

17. The calender (1) according to claim 16, in which the bearings (8, 9, 10, 11) of two of the four bearing rows (A, B, C, D) are clamped in alignment with one another, and wherein, between two adjacent rollers (3), in each case one bearing (8, 9, 10, 11) of a first remaining bearing row (A, B, C, D), which rows are not clamped in alignment with one another, is diagonally clamped to a bearing (8, 9, 10, 11) of a first of the bearing rows (A, B, C, D) of the adjacent roller (3), which rows are clamped in alignment with one another, a bearing (8, 9, 10, 11) of a second remaining bearing row (A, B, C, D), which rows are not clamped in alignment to one another, is diagonally clamped to a bearing (8, 9, 10, 11) of a second of the bearing rows (A, B, C, D) clamped in alignment to one another of the adjacent roller (3).

18. The calender (1) according to claim 17, in which the bearings (9) of the second bearing row (B) are clamped in alignment with one another and the bearings (11) of the fourth bearing row (D) are clamped in alignment with one another, and between two rollers (3) in each case one bearing (8) of the first bearing row (A) of a first of the adjacent rollers (3) is diagonally clamped to a bearing (9) of the second bearing row (B) of the adjacent roller (3), and one bearing (10) of the third bearing row (C) of the first of the adjacent rollers (3) is diagonally clamped to a bearing (11) of the fourth bearing row (D) of the adjacent roller (3).

19. The calender (1) according to claim 17, in which the bearings (8) of the first bearing row (A) are clamped in alignment with one another and the bearings (11) of the fourth bearing row (D) are clamped in alignment with one another, and between two rollers (3) in each case one bearing (9) of the second bearing row (B) of a first of the adjacent rollers (3) is diagonally clamped to a bearing (8) of the first bearing row (A) of the adjacent roller (3), and one bearing (10) of the third bearing row (C) of the first adjacent roller (3) is diagonally clamped to a bearing (11) of the fourth bearing row (D) of the adjacent roller (3).

20.-32. (canceled)
